(19) United States
(12) Patent Application Publication
(10) Pub. No.: US 2005/0017040 A1
(43) Pub. Date: Jan. 27, 2005

(54) Carrying case useful to carry and secure items

(75) Inventors: Joan C. Roberts, Pearland, TX (US); Craig A. Roberts, Friendswood, TX (US); Thomas R. Roberts, Pearland, TX (US)

Correspondence Address: KEITH R. DERRINGTON, P.C., 10260 WESTHEIMER, SUITE 465, HOUSTON, TX, 77042, US

(73) Assignee: CASINOSENTRY INCORPORATED

(21) Appl. No.: 10/882,919

(22) Filed: Jul. 1, 2004

Related U.S. Application Data
(60) Provisional application No. 60/486,105, filed on Jul. 10, 2003.

(51) Int. Cl. G06K 19/06; A45F 3/02; A45C 13/30; A45C 1/04; F41C 33/02; F42B 39/02

(52) U.S. Cl. 224/617; 224/605; 224/665

(57) ABSTRACT

A carrying case useful to retain items within such that the items are held secure within the case wherein the items are also easily retrievable. The case includes locking security measures for protecting the items against theft and loss such as by neglect. The case has specific utility within the confines of certain gaming establishments, such as wagering parlors and casinos.

### RELATED APPLICATIONS

This application claims priority from co-pending U.S. Provisional Application No. 60/486,105, filed Jul. 10, 2003, the full disclosure of which is hereby incorporated by reference herein.

### BACKGROUND OF THE INVENTION

1. Field of the Invention

The invention relates generally to a case useful for carrying items. More specifically, the present invention relates to a case in which items can be stored and secured. Yet even more specifically, the present invention relates to a case that can store items, ensure that items that are stored are protected against loss due to theft or accident, and provides to the user of the case easy access to the items stored within the case.

2. Description of Related Art

Patrons of gaming establishments, such as casinos, race tracks, bingo parlors and the like often carry with them valuables such as cash, travelers' checks, credit cards, value added cards, personal checks, and jewelry. As is known, value added cards includes casino cards that can be purchased at a gaming establishment for use in games of chance such as slot machines. Before a user obtains a value added card, they must first provide personal information to the casino. This information is encoded onto the card and in many machines, such as slot machines, the user inserts the card into the machine during play. Thus the casino can track the type and denomination of the machine the user is playing. They also know how much the user spends, wins, and loses, as well as when the user starts playing and stops. While at a table, the casino basically tracks the amount of time the user spends playing. At the user's request, the dealer or pit boss marks the amount spent. Based on the recorded gaming habits of the particular patron, the casino then will mail out complimentary rewards that can include a free room, food, shows, cash rebates, items such as hats, tee-shirts, cups, etc., information on special promotions, and sometimes a free flight plus room and food to a casino. Each casino has a different scoring system, but based on the number of points the patron acquires, their play is rated and they can be eligible for a silver, gold, or platinum card (each club may have different terms used for rating). The higher the rating, the better the complimentary rewards (comps). Earning comps is a way of getting something extra for the patron's casino dollar. All comps are specific to the individual to which they are assigned and cannot be used by anyone else.

The cost of a value added card varies depending on how much credit the original purchaser wishes to have included with the card. As used the monetary value stored on the card will be deducted or reduced with each particular use, at the discretion of the user, additional value can be added to the card. Value added cards often are not specific to a user, such as a credit card, and if lost or stolen can be readily used by an unauthorized person who did not purchase the value added card. Thus when lost or stolen, the original purchaser has effectively been deprived of the economic value remaining on the card. Accordingly such value added cards can be the subject of theft These valuables are carried by the patrons either because they are needed by the patron to participate in activities of the gaming establishment or because the patrons are visiting the location where the establishment is, and wish to retain these items on their person for safe keeping. Unfortunately, because it is known by criminals that gaming establishment patrons often carry such valuables, the patrons are subject to theft while in and around the gaming establishments.

One solution to help prevent or deter theft of the valuables is to store the valuables in a bag held by or secured to the gaming patron—such as a waist bag. However, the known bags suffer from one or more disadvantages. For example, some waist bags are too boxy and inflexible, this hinders the ability of the patron to participate in some gaming activities that may require the patron to lean over tables to either place bets or collect winnings. Many bags are inconvenient as they fail to include a “hands-free” option of belt clips or the manner and direction of opening the particular bag is limited. Other bags are impractical to use within a gaming establishment due to their size and subjects the patron to possible unnecessary searches in this day of increased security. Further the prior art bags fail to provide the storage necessary for various valuables while providing for easy access by the owner or user of the bag. Examples of these can be found in the following patents: U.S. Pat. No. 5,586,706, U.S. Pat. No. 5,797,529, U.S. Pat. No. 5,887,770, U.S. Pat. No. 5,169,043, U.S. Pat. No. 6,446,688, U.S. Pat. No. 5,836,497, U.S. Pat. No. 5,158,220, and U.S. Pat. No. 4,974,761.

Furthermore, casino patrons that carry valuables require a safe place to practically store certain items. Items such as cash, value added or casino cards, checks, writing instruments, identification, keys, as well as other personal items, are valuable items often carried by casino patrons requiring a secure storage location that is convenient to access. None of the references cited herein are capable of providing a safe secure space suitable for storing such items that can be readily retrieved by the user of the bag. Therefore, a need exists for a case that can be carried within a gaming establishment, where the case provides security devices to protect against theft and also provides devices to prevent the owner from misplacing items or leaving items due to forgetfulness. Further a need exists for a gaming case that includes an alarm that alerts the user of the case, or resident security personnel, upon theft or attempted theft of the case.

### BRIEF SUMMARY OF THE INVENTION

One embodiment of the present invention includes a case having an inside, an outside, a top side, a bottom side, a second vertical side, a first vertical side, a first lateral side, and a second lateral side. A pocket is also included that is disposed on the second lateral side with at least one retaining ring disposed on the pocket. The retaining ring can be used to anchor or tether securable items such as casino cards, club cards, credit cards and the like, wherein the user can have easy access to the securable item and yet will not lose or misplace the item since it is secured to the case. Furthermore, the item can be inserted into an outer pocket of the case, while still tethered, when the securable item is not in use. A series of mating hook and loop fasteners can be disposed on the second lateral side and on the surface of the pocket facing the second lateral side. Wherein the series of mating hook and loop fasteners are capable of forming at least two compartments within the pocket. An opening is also provided in conjunction with the present invention that is preferably on the top side of the case thereby providing access to the inside of the case.

The case can also include a slide fastener provided on the top side, where the slide fastener is capable of sealing and unsealing the opening. The slide fastener can be a sealing ridge and at least one lock tab or can be a zipper. A strap can be included inside of the case capable of supporting a writing instrument, smaller straps can be included within the inside of the case for smaller diameter writing instruments. The slide fastener can further comprise a first and a second locking tab thereby allowing the top side to be opened or closed by sliding the locking tab from either end of the slide fastener. To maintain the top side in a closed position, each of the locking tabs are securable to one of either the second vertical side or the first vertical side.

One embodiment of the case of the present invention can include a first inner pocket disposed within the inside of the case proximate to the first lateral side, where the first inner pocket is selectively securable to the inside of the case. Optionally disposed within the first inner pocket is a first partition thereby providing a first and second section within the first inner pocket. The present invention also includes a second inner pocket disposed within the inside of the case proximate to the first lateral side, wherein the second inner pocket is selectively securable to the inside of the case. The case of the present invention further includes at least one flap disposed on the first and second inner pocket where the at least one flap is capable of securably retaining at least one card within. The case of the present invention is useful for carrying valuable items within and securing said valuable items within said case thereby preventing accidental loss or theft of said valuable items wherein the valuable items are selected from the list consisting of cash, personal checks, travelers' checks, keys, charge credit cards, identification, and value added cards.

### BRIEF DESCRIPTION OF THE SEVERAL VIEWS OF THE DRAWING

FIG. 1 is a side view of the case of one embodiment of the present invention.

FIG. 2 provides a side view of one of the inner sides of the case of one embodiment of the present invention.

FIG. 3 is an alternative side view of one embodiment of the case of the present invention.

FIG. 4 provides an alternative side view of one of the inner sides of the case of one embodiment of the present invention.

FIG. 5A provides a frontal view of one embodiment of the present invention.

FIG. 5B provides an overhead view of one embodiment of the present invention.

FIG. 6 provides an inside view of one embodiment of the present invention.

FIG. 7 provides an overhead view of one embodiment of a slide fastener.

FIG. 8 provides one embodiment of a strap for use with the present invention.

FIG. 9 provides an alternative embodiment of the present invention.

### DETAILED DESCRIPTION OF THE INVENTION

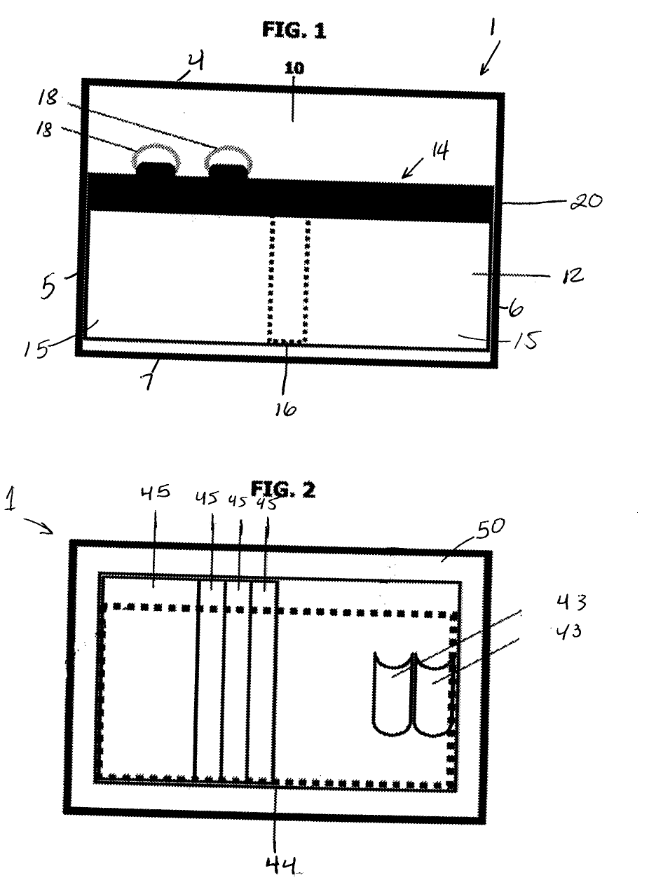

With reference to the drawing herein, one embodiment of a case 1 useful for carrying items is shown in FIG. 1. The case 1 is preferably substantially rectangular in configuration thereby having a top side 4, a bottom side 7, a first vertical side 5, a second vertical side 6, a first lateral side 36, and a second lateral side 10. The case 1 can be comprised of any woven material such as cotton, linen, nylon, polyester, canvas, combinations thereof, or any other now known or later developed suitable material. Both natural and synthetic leather can be included as a material of manufacture for the case 1 of the present invention. As shown in FIG. 1, provided on the second lateral side 10 of the case 1 is a pocket 12. Preferably the pocket 12 is disposed substantially along the length of the case 1 and has an upward facing pocket opening 14 that also runs parallel to the length of the case 1. A divider 16 within the pocket 12 provides a releasable securing function such that when the divider 16 is in the securing mode, the pocket 12 is divided into two, preferably equally sized, pouches. Also shown in FIG. 1 are retaining rings 18 secured to the pocket lip 20. Preferably the pocket lip 20 is comprised of a reinforced strip of heavier material that is structurally stronger than the remaining portion of the pocket 12. While shown as “D” rings, the retaining rings 18 can take any form suitable for providing an anchoring function on which to tether a retaining line 19, lanyard, clip, latch, or any other device capable of being attached to the retaining rings 18. One of the many advantages of this embodiment of the present invention is that the user of the case 1 can remove items from the pocket 12 and yet at the same time the items can still be anchored to the case 1 by virtue of an attached retaining line 19. Further, the divider 16 can improve the flexibility of what can be carried in the pocket 12. For example, the divider 16 can be placed in the release mode thereby allowing an object or item to be placed along the entire length of the pocket 12. Alternatively, the divider 16 can be in the secured mode (i.e. attaching the pocket 12 to the outer surface of the case 1) such the pocket 12 is then capable of carrying items within each of the smaller pouches 15. In the specific example of a gaming house, an individual having a value added card 37, such as a casino club card, for gaming devices, such as slot machines, can secure the value added card 37 to the case 1 by attaching one end of the retaining line 19 to the value added card 37 and attaching the other end of the retaining line 19 to one of the retaining rings 18 on the case 1. The ability to selectively secure a value added card 37 to the case 1 not only helps to prevent the value added card 37 from being stolen from its owner, it can also prevent the value added card 37 from being inadvertently dropped or accidentally left at a gaming station.

An opening 22 is provided on the top of the case 1 that can be opened or closed by a slide fastener 21 such as a zipper or a tongue and groove arrangement. A tongue and groove arrangement (not shown) comprises a protruding edge on one lip of the opening with a corresponding groove on the opposing lip of the opening. As is well known, both the zipper and the tongue and groove arrangement can be used to seal or unseal the opening 22 by traversing a first tab 26 across the respective length of the zipper or the tongue and groove arrangement. An optional second tab 27 can also be provided onto the slide fastener 21 to allow for sealing or unsealing the opening 22 from either end of the case 1.

End retaining rings 29 can be added to the ends 30 of the case 1. Implementation of the end retaining rings 29 provides many advantages, such as the ability to attach a carrying strap 32 to the ends 30 of the case 1 so that the case 1 can be carried over the shoulder of the user or around the waist of the user. The carrying strap 32 can include an adjustment buckle 33 for adjusting the length of the carrying strap 32 and strap latches 31 provided at its ends for attaching the carrying strap 32 to the case 1. The inclusion of the carrying strap 32 with the case 1 provides for seamless carrying of the case 1, seamless carrying describes how the user can secure or attach the case 1 to its person without the feeling of being burdened by the case 1.

Another advantage provided by the end retaining rings 29 is the ability to securely close the opening 22 when used with a latch clip 34. The latch clip 34 can be secured to one of the tabs (26 or 27) with a latch clip ring 35. When the slide fastener 21 is in the closed position, the latch clip 34 can be connected to the tab (26 or 27) via the latch clip ring 35 on one end and simultaneously latched to one of the end retaining rings 29. Thus when latch clip 34 is used to anchor the closing tab (26 or 27) to an end retaining ring 29, the case 1 cannot be opened without unlatching or removing the latch clip 34. Accordingly, the case 1 of the present invention provides the capability of preventing theft of the contents of the case 1 by hindering the opening of the case 1.

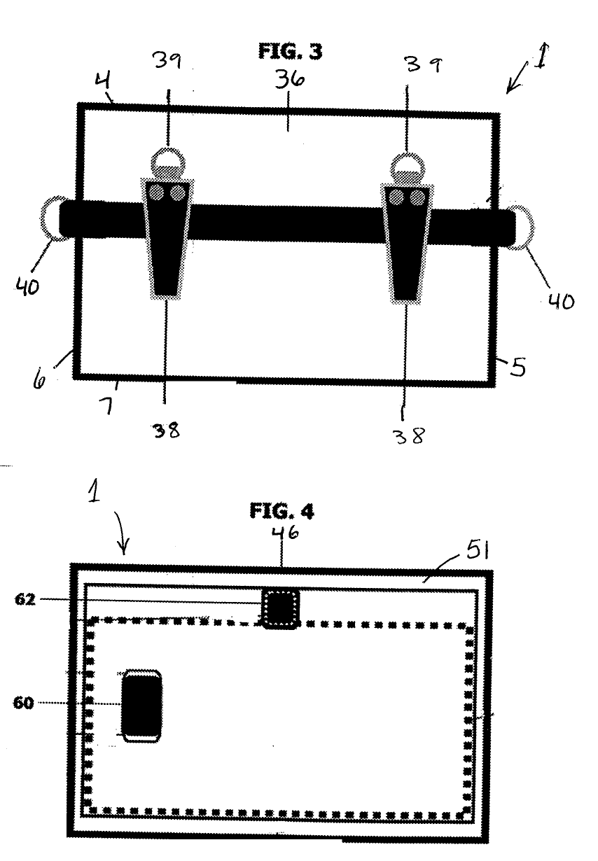

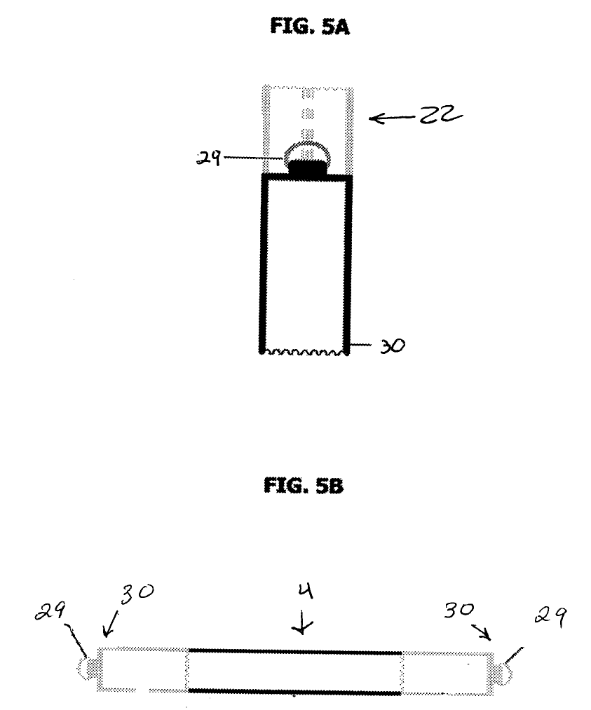

Referring now to FIG. 3 illustrating a first lateral side 36 of the present invention, disposed thereon are clips 38, clip rings 39, and strap rings 40. The clips 38 can provide a manner of placing the case 1 on one's belt for carrying and holding the case 1. While two clips 38 are preferred, one, or more than two clips 38 may be included with the case 1. On the clip rings 39 various items can be secured thereto for the sake of convenience and to prevent loss, such as keys, additional lanyards, or to keep other small items within easy reach. The strap rings 40 can be used as a connection point on which to attach a strap for carrying the case 1 around the waist of a user—the type of strap considered is not critical to the invention, but can be any now known or later developed strap device.

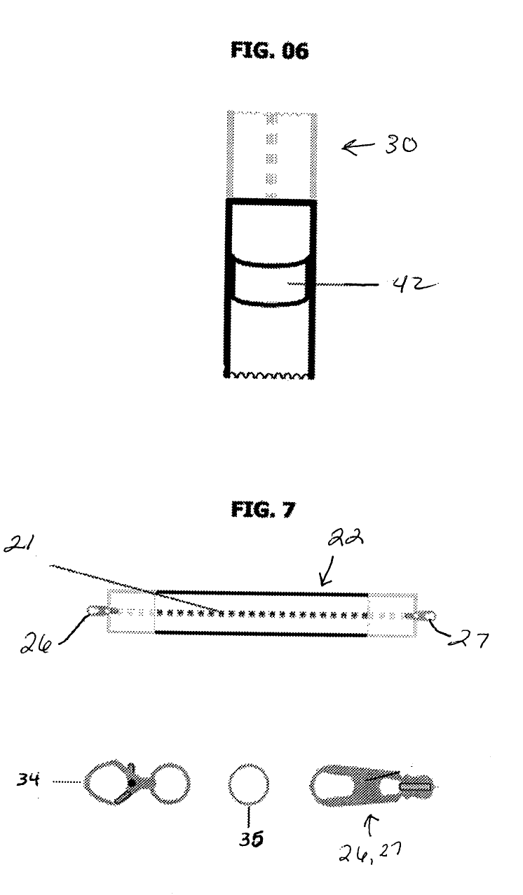

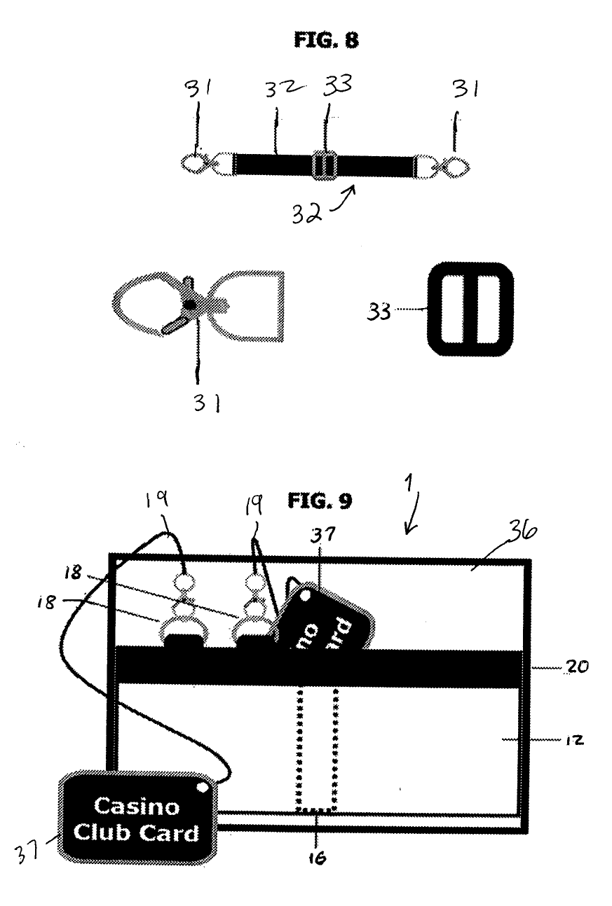

As seen in FIGS. 2, 4, and 6 the inside of the case 1 includes many additional novel features. More specifically, as illustrated in FIG. 6, straps 42 are included suitable for securing a writing instrument and other items such as Bingo daubers, highlighters, medicine containers, lighters, etc. Optionally the straps 42 can be comprised of an elastic material that is expandable and can accommodate the differing sizes of objects therein. A first inner pocket 44 and a second inner pocket 46 are disposed within the case 1 that extends along the length of each lateral side of the case 1. One embodiment of the first inner pocket 44 is displayed in outline form as it is to be situated between the first inner pocket 44 and the first inside lateral wall 50. Along the surface of the first inner pocket 44 facing toward the middle of the case 1 are flaps 45. The flaps 45 are capable of receiving and securing cards, such as credit cards, gaming cards, driver's licenses, value added cards, hotel room key cards and the like. The flaps 45 preferably extend in a vertical orientation that separate and organize the cards to facilitate ready identification of the cards when desired by the user of the case 1. Additionally, the flaps 45 can be oversized to allow ease of removal and insertion of the cards so that the user's attention is not diverted for longer than necessary and can thus remain attentive to potential theft. Further, an oversized flap 45 can prevent accidental removal of other cards if two cards happen to be placed in a single slot.

Included between the first inner pocket 44 and the first inside lateral wall 50 of the case 1 is preferably one first partition (not shown)—however if needed additional partitions could be included. The first inside lateral wall 50 runs along the inside of the case 1 just opposite of the first lateral side 36 of the case 1. The presence of the first partition separates the first inner pocket 44 into at least two separate spaces. The first inner pocket 44 is capable of storing items for easy retrieval such as coupons, papers, and other non-sensitive items. Optionally provided on the front of the first inner pocket 44 are holders 43 suitable for holding and securing elongated items such as pens, pencils, and other such items. While two holders 43 are shown, only one, or more than two may be provided depending on the specific application.

A second inner pocket 46 (shown in outline form similar to the first inner pocket 44) is disposed on the inside of the case 1 opposite to the first inner pocket 44 against the second inside lateral wall 51. The second inside lateral wall 51 runs along the inside of the case 1 just inside of the second lateral side 10. Similarly to the first inner pocket 44, at least one second partition (not shown) is provided within the second inner pocket 46 thereby separating the second inner pocket 46 into two or more sections. The second inner pocket 46 is releasably securable to the second inside lateral wall 51 with an inside fastener 62 thereby creating a securing pocket that provides an additional advantage of security to the present invention. The inside fastener 62 can releaseably secure the second inner pocket 46 to the second inside lateral wall 51 by snaps or hook and loop fasteners. It is preferred that the inside fastener 62 make an easily detectable sound when the second inner pocket 46 is opened, thereby alerting the user of the case 1 if an attempt is made to gain unauthorized entry to the second inner pocket 46. Thus valuables, including cash, travelers' checks, personal checks, jewelry, or room keys, can be stored within the second inner pocket 46 and secured therein to prevent against loss due to theft or accident. Further, the nature of the securing device enables the valuables to be securely stored within the second inner pocket 46 and yet readily available to the owner of the case 1. Optionally, a key fob retaining strap 60 can be sewn to the surface of the second inner pocket 46 having releasable fasteners at each of its ends, such as hook and loop fasteners or snaps. This provides a releasably securing spot within the case 1 for a ring having items such as keys attached thereto.

In an alternative embodiment of the present invention, a commercially available small, lightweight alarm system (not shown) can be attached to the inside of the case 1 by a device that permits easy release and removal when desired. Attached to the alarm is a cord that activates the alarm when pulled. To facilitate entry of the cord (not shown) into the case 1, a grommet (not shown) can be installed in the lower portion of the second lateral side 10 of the case 1. The cord attached to the alarm inside the case 1 is then run through the grommet and attached to a separate clothing clip (not shown) that can be attached to any part of the clothing of the user of the case 1. The clothing clip should include a heavy duty snap attached to the outside of the clip that accepts a heavy duty snap attached to the end of the alarm cord (not shown). If an attempt is made to steal the case 1 while the alarm cord is attached to the alarm and the clothing clip, the alarm cord is pulled, setting off the alarm inside the case 1. The snap releases the alarm cord from the user's clothing to protect the user from the thief, but the alarm continues to sound alerting security or those around. If the case 1 is then opened, there is a strobe light (not shown) also activated atop the alarm when the alarm cord is pulled that further serves to attract attention from security and others. A hidden disarm switch (not shown) in the alarm prevents the thief from disarming it. This embodiment can also be activated by case 1 user should the user be attacked.

In yet another alternative embodiment of the present invention, the flaps 45 in the present invention can be flat, rectangular pieces of leather, cloth, or combinations thereof to which four or more credit-card-size sleeves are sewn. The flaps 45 of this alternative invention can be attached within the case 1 by a strip of hook and loop material. The flaps 45 could include a grommet (not shown) installed in one corner of the section of the flaps 45. A rivet (not shown) in the bottom of the case 1 can be used to anchor a length of chain or other sturdy material to the case 1. On the opposite end or free end of the chain, a snap hook can be attached. This snap hook can then attached to the grommet in the corner of the section of the flaps 45. This permits the section of the flaps 45 to remain attached to case 1 but be extended the length of the chain outside of the case 1 when needed.

While the specificities detailed herein are for meeting the needs of the casino gaming patron, there are much broader uses for this bag beyond the obvious of carrying smaller items. The design lends itself to the convenience of easy access to small, handheld electronic devices such as PDA's, cell phones, for example, while providing a way to securely attach them to the bag using the D-rings sewn to the pocket on the front panel of the case 1 or the small D-rings on the belt clips on the exterior back panel of the case. The businessperson, professional, student, sports enthusiast, and others could carry these items and other personal items without the need to clutter pockets, briefcases, backpacks, etc. that are designed to carry other items.

In another alternative embodiment, on either the first or second lateral side (36 or 10) of the case 1, a strip of heavy material with a fold sewn at each end can be attached. The folds can form a loop within which a D-ring is placed; this configuration could be sewn on the strap that passes under the clips 38. This would allow the top of the case 1 to be held flush against the body when the belt material is attached to the strip placed above the existing strip under the belt clips. The wearer would have a choice of two places to attach the belt snaps.

The pockets (44 and 46) on the inside of the case 1 and on the outside of the case 1 (12) can be resized for other specific uses. This can be accomplished by altering the size of the length and width of the gussets on the pocket sewn to the front panel of the case 1 and/or altering the depth and width of the said pocket. The pocket 12 on the outside of the case 1 can be removed and smaller pockets can be sewn on the surface of the second lateral side 10. A pocket of mesh or other material can be added to the first or second lateral side (36 or 10) of the case 1 to carry a cell phone or other items.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. For example, the straps can be comprised of any woven material such as cotton, linen, canvas, nylon, polyester, leather, or combinations thereof. These and other similar modifications will readily suggest themselves to those skilled in the art, and are intended to be encompassed within the spirit of the present invention disclosed herein and the scope of the appended claims.

1. A case useful for carrying and securing items comprising:
an inner compartment;
at least one securing strap; and
an anchoring device capable of securedly tethering a securable item to said case.

2. The case of claim 1, wherein said securable item is selected from the group consisting of value added cards, casino cards, and credit cards.

3. The case of claim 1 further comprising an opening providing access to said inner compartment and a slide fastener disposed on said opening suitable for opening and closing said opening, wherein said slide fastener is securably disposed into a closed position.

4. The case of claim 1 further comprising an inner compartment having a securable opening wherein activation of said opening is noticeable.

5. The case of claim 1 further comprising a carrying means, said carrying means selected from the list consisting of a strap secured on its ends to said case suitable for carrying on a shoulder, a strap secured on its ends to said case suitable for carrying on a waist, and at least one clip secured to said case.

6. The case of claim 1, wherein said anchoring device comprises at least one ring secured to said case, a lanyard secured to said at least one ring on one end and to the securable item on its other end, thereby anchoring said securable item to said case.

7. A case useful for securing personal items therein and adapted for seamless carrying by its user, said case comprising:
an inner compartment having an opening;
a slide fastener disposed on said opening capable of being manipulated into an open and a closed position; and
a securing latch provided on said slide fastener, wherein said securing latch is capable of selectively securing said slide fastener in a closed position.

8. The case of claim 7 further comprising a pocket disposed on the outer surface of said case and a releasable securing dividing strip vertically disposed within said pocket, wherein securing said dividing strip separates said pocket into at least two distinct pockets.

9. The case of claim 7 further comprising a first anchoring ring disposed proximate to one end of said slide fastener and a second anchoring ring disposed proximate to the other end of said slide fastener, wherein said securing latch is selectively securable to said first anchoring ring and to said second anchoring ring.

10. The case of claim 7 further comprising two sliding tabs disposed on said slide fastener, wherein said securing latch selectively latches said two sliding tabs together thereby maintaining said slide fastener in a closed position.

11. The case of claim 7 further comprising at least one slot disposed within said inner compartment formed to receive at least one card, wherein said slot is oversized for easy insertion and retrieval of said card.

12. The case of claim 11, wherein said card is selected from the group consisting of a credit card, a value added card, a casino card, a hotel room key card, and a drivers' license.

13. The case of claim 7 further comprising an anchoring device connected to said case and adapted to tether a securable item to said case.

14. A casino case useful for stowing valuable items therein and releasably securable to its user, said case comprising:
an inner compartment formed to receive valuable items for stowage;
a securing pocket disposed within said inner compartment; and
a releasable locking mechanism provided with said securing pocket, wherein the unreleasing of said locking mechanism is noticeable to the user.

15. The case of claim 14 further comprising at least one strap disposed within the inside of said case capable of supporting a writing instrument.

16. The case of claim 14 further comprising, a first partition disposed within said first inner compartment thereby providing a first and second section within said first inner compartment.

17. The case of claim 14 further comprising a slide fastener for opening and closing said inner compartment, a first anchoring ring disposed proximate to one end of said slide fastener and a second anchoring ring disposed proximate to the other end of said slide fastener, wherein said securing latch is selectively securable to said first anchoring ring and to said second anchoring ring.

18. The case of claim 14 further comprising an anchoring device connected to said case and adapted to tether a securable item to said case.
